(19) United States
(12) Patent Application Publication
(10) Pub. No.: US 2016/0344060 A1
(43) Pub. Date: Nov. 24, 2016

(54) THIN BATTERY AND BATTERY-MOUNTED DEVICE

(71) Applicant: PANASONIC INTELLECTUAL PROPERTY MANAGEMENT CO., LTD., Osaka-shi (JP)

(72) Inventors: YUYA ASANO, Osaka (JP); TOMOHIRO UEDA, Osaka (JP); YOKO SANO, Osaka (JP)

(73) Assignee: Panasonic Intellectual Property Management Co., Lt, Osaka (JP)

(21) Appl. No.: 15/111,795

(22) PCT Filed: Feb. 12, 2015
(86) PCT No.: PCT/JP2015/000624

§ 371 Date: Jul. 14, 2016

(30) Foreign Application Priority Data
Mar. 12, 2014 (JP) 2014-048958

(51) Int. Cl. H01M 10/04; H01M 2/16; H01M 2/10; H01M 10/0525

(52) U.S. Cl. CPC H01M 10/0436; H01M 10/0525; H01M 2/168; H01M 2/1061; H01M 2004/021

(57) ABSTRACT

A thin battery including a sheet-like electrode assembly; a non-aqueous electrolyte with which the electrode assembly is impregnated; and a housing in a sealed manner. The electrode assembly includes a pair of first electrodes disposed at outermost sides of the electrode assembly, at least one second electrode disposed between the pair of first electrodes, and a first separator disposed therebetween. The first and second electrodes respectively include first and second current collector sheets and first and second active material layers attached to one surface of the first and second current collector sheets. The first separator is bonded to the first active and second active material layers. Sliding resistance R11 between the first separator and each first active material layer and sliding resistance R12 between the first separator and each second active material layers satisfy:

0.5 N/cm²≦R11<R12≦2.3 N/cm².

### TECHNICAL FIELD

The present invention relates to a thin battery including a sheet-like electrode assembly, a non-aqueous electrolyte with which the electrode assembly is impregnated, and a housing for accommodating the electrode assembly and the non-aqueous electrolyte in a sealed manner, and relates to a battery-mounted device in which the thin battery is mounted.

### BACKGROUND ART

In recent years, thin batteries have been used as power sources for small-sized electronic equipment such as biological wearable devices, portable telephones, recording and playing-back devices, wristwatches, video and still cameras, liquid crystal displays, electronic calculators, IC cards, temperature sensors, hearing aids, and pressure-sensitive buzzers. Such thin batteries are required to have flexibility. For example, a thin battery to be mounted to a biological wearable device or a wearable portable terminal is required to change form in response to the movement of a living body. Thus, a thin battery having a housing made of a thin and flexible laminate film has been proposed (see PTL 1).

### CITATION LIST

### Patent Literature

### PTL 1: Japanese Patent Application Unexamined Publication No. 2013-48041

### SUMMARY OF THE INVENTION

### Problems to be Solved by the Invention

It is premised that a thin battery is highly flexible, the thin battery needs to maintain battery performance even when it is deformed. However, when a thin battery is significantly bent in an arc shape, an excessive tensile load is applied to an electrode located at the protruding outermost side. Consequently, an electrode located at the outermost side may break, thus extremely decreasing the battery performance.

### Means to Solve the Problem

In view of the foregoing, a first aspect of the present invention relates to a thin battery including: a sheet-like electrode assembly; a non-aqueous electrolyte with which the electrode assembly is impregnated; and a housing for accommodating the electrode assembly and the non-aqueous electrolyte in a sealed manner. The electrode assembly includes a pair of first electrodes disposed at outermost sides of the electrode assembly, a second electrode disposed between the pair of first electrodes, and a first separator disposed between each of the first electrodes and the second electrode. Each of the first electrodes includes a first current collector sheet and a first active material layer attached to one surface of the first current collector sheet. The second electrode has a polarity different from a polarity of each of the first electrodes, and includes a second current collector sheet and second active material layers attached to both surfaces of the second current collector sheet. The first separator is bonded to each of the first active material layers and each of the second active material layers. Sliding resistance R11 between the first separator and each of the first active material layers and sliding resistance R12 between the first separator and each of the second active material layers satisfy the following mathematical expression 1;

0.5 N/cm²≦R11<R12≦2.3 N/cm².

A second aspect of the present invention relates to a battery-mounted device including the thin battery as mentioned above; flexible electronic equipment to be driven by electric power supplied from the thin battery, and in which the thin battery and the electronic equipment are integrated together to form a sheet.

### Advantageous Effect of Invention

According to the present invention, even when a thin battery and a battery-mounted device are significantly bent in an arc shape, and an excessive tensile load is applied to a first electrode located at the protruding outermost side, sliding is generated at an interface between a first active material layer of the first electrode and a first separator, and the tensile load is relieved. Therefore, breakage of the first electrode located at the outermost side is suppressed.

### BRIEF DESCRIPTION OF THE DRAWINGS

FIG. 1 is a perspective view showing an example of a battery-mounted device (biological wearable device) including a thin battery.

FIG. 2 is a perspective view showing an example of an appearance of the device when deformed.

FIG. 3 is a plan view of a thin battery in accordance with a first exemplary embodiment of the present invention.

FIG. 4 is a longitudinal sectional view conceptually showing a structure of an electrode assembly of the thin battery in accordance with the first exemplary embodiment of the present invention.

FIG. 5 is a longitudinal sectional view conceptually showing a structure of an electrode assembly of a thin battery in accordance with a second exemplary embodiment of the present invention.

FIG. 6 is a view to illustrate a measurement method of a capacity retention rate after a bending test.

FIG. 7 is a schematic drawing of a test piece used for measurement of sliding resistance.

### DETAILED DESCRIPTION OF THE PREFERRED EMBODIMENT

A first aspect of the present invention relates to a thin battery including a sheet-like electrode assembly, a non-aqueous electrolyte with which the electrode assembly is impregnated, and a housing for accommodating the electrode assembly and the non-aqueous electrolyte in a sealed manner. The electrode assembly includes a pair of first electrodes disposed at outermost sides thereof, a second electrode disposed between the pair of first electrodes, and a first separator disposed between each of the first electrodes and the second electrode. Each of the first electrodes includes a first current collector sheet and a first active material layer attached to one surface of the first current collector sheet. The second electrode has a polarity different from that of each of the first electrodes, and includes a second current collector sheet and second active material layers attached to both surfaces of the second current collector sheet.

Herein, the first separator is bonded to each of the first active material layers and each of the second active material layers. Sliding resistance R11 between the first separator and the first active material layer and sliding resistance R12 between the first separator and the second active material layer satisfy mathematical expression

0.5 N/cm²≦R11<R12≦2.3 N/cm². (1)

When the thin battery is significantly bent in an arc shape, an excessive tensile load is applied to an electrode located at the protruding outermost side. Consequently, the electrode located at the outermost side is likely to break. On the other hand, when the sliding resistance R11 between the first separator and the first active material layer and the sliding resistance R12 between the first separator and the second active material layer satisfy the above-mentioned mathematical expression (1), R11<R12 is always satisfied. Consequently, sliding occurs more preferentially at an interface between the outermost first electrode to which the largest tensile load is applied and the first separator as compared with at an interface between the more inner second electrode and the first separator. Thus, a load is relieved at the outermost part of the electrode assembly.

Furthermore, when the above-mentioned mathematical expression (1) is satisfied, the relation: 0.5 N/cm²≦R11 is satisfied. Therefore, separation between the first electrode and the first separator does not easily occur. In view of suppressing breakage of the first electrode, it is desirable to reduce sliding resistance R11. However, at the time of R11<0.5 N/cm², separation may occur between the first electrode and the first separator.

Furthermore, when R12≦2.3 N/cm² is satisfied, sliding occurs before excessive stresses accumulate also at the interface between the second electrode and the first separator. Thus, the flexibility of the electrode assembly is improved, and not only the breakage of the first electrode but also the breakage of the second electrode is remarkably suppressed.

A thin battery having the simplest structure includes a pair of first electrodes disposed at the outermost sides of the electrode assembly, one second electrode disposed between the pair of first electrodes, and a first separator interposed between each of the first electrodes and the second electrode. That is to say, the electrode assembly includes two first electrodes, one second electrode, and a separator (first electrode-second electrode-first electrode). Note here that the first separator may include two first separators. Alternatively, however, one first separator may be folded around one second electrode such that the first separator may be interposed between the two first electrodes and one second electrode.

A thin battery having another structure includes two or more second electrodes, and further includes one or more third electrodes disposed between a pair of the second electrodes. Herein, the third electrode has the same polarity as that of each of the first electrodes, and includes a third current collector sheet and third active material layers attached to both surfaces of the third current collector sheet. In this case, each second electrode and each third electrode are alternately disposed. For example, the third electrode (having the same polarity as that of each of the first electrodes) is disposed in the center of the electrode assembly. The third electrode is disposed between the pair of second electrodes. Each of the second electrodes and the third electrode are disposed with a second separator interposed therebetween. The pair of the first electrodes sandwich a laminated body of the second electrodes and the third electrode (first electrode-second electrode-third electrode-second electrode-first electrode).

At this time, sliding resistance R22 between the second separator and each of the second active material layers satisfies mathematical expression

R11<R22≦2.3 N/cm². (2)

Furthermore, it is preferable that sliding resistance R23 between the second separator and each of the third active material layers satisfies mathematical expression

R11<R23≦2.3 N/cm². (3)

When the above-mentioned mathematical expressions (2) and (3) are satisfied, the sliding resistance R11 between the first active material layer of the outermost first electrode and the first separator is always minimum. Consequently, when the thin battery is significantly bent in an arc shape, sliding always occurs preferentially in the interface between the first active material layer and the first separator, and a tensile load is relieved. Furthermore, since R22≦2.3 N/cm² and R23≦2.3 N/cm² are satisfied, sliding occurs before excessive stresses accumulate also at the interface between the second electrode or the third electrode and the second separator.

In more generalization, a thin battery of still another structure may include n second electrodes, and n−1 third electrodes, wherein n is an integer of 2 or more. For example, when n is 3, the second electrode is disposed in the center of the electrode assembly. The second electrode located in the center is disposed between a pair of the third electrodes. A laminated body composed of the second electrode in the center and the pair of third electrodes sandwiching the second electrode is sandwiched between the pair of second electrodes, and the resultant laminated body is further sandwiched between the pair of first electrodes (first electrode-second electrode-third electrode-second electrode-third electrode-second electrode-first electrode).

It is preferable that porosity A of the first active material layer is larger than porosity B of the second active material layer. Thus, a contact area between the first active material layer and the first separator is smaller than a contact area between the second active material layer and the first separator. Thus, sliding resistance R11 can be made smaller than R12 easily.

It is preferable that at least a part of the non-aqueous electrolyte with which the electrode assembly is impregnated forms a gel electrolyte. It is preferable that the gel electrolyte is interposed in at least a first region between the first active material layer and the first separator, and in a second region between the second active material layer and the first separator. At this time, it is preferable that the gel electrolyte is distributed more in the second region than in the first region. Thus, sliding resistance R11 can be made smaller than R12 more easily. This is because the gel electrolyte functions as an adhesive agent for the active material layer and the separator, and therefore the smaller the distributed amount of the gel electrolyte is, the smaller the sliding resistance becomes.

When the first active material layer includes a first active material and a first binder, and the second active material layer includes a second active material and a second binder, it is preferable that all of the gel electrolyte, the first binder, and the second binder contain a resin swollen with a non-aqueous electrolyte. This suppresses separation between each of the electrodes and each of the separators in the electrode assembly, and thus easily suppresses the degradation of the battery performance.

As the resin swollen with a non-aqueous electrolyte, a fluorocarbon resin including a polyvinylidene fluoride unit is preferred. The fluorocarbon resin including a polyvinylidene fluoride unit easily retains a non-aqueous electrolyte, and is easily gelled. Consequently, the adhesiveness between each electrode and each separator is improved and separation therebetween is further suppressed.

In one exemplary embodiment, an area of the first active material layer is larger than an area of the second active material layer. Herein, an area of each of the active material layers refers to a projected area (S) seen from the normal direction of the active material layer (the direction perpendicular to the planer direction of a current collector sheet).

A second aspect of the present invention relates to a battery-mounted device including a thin battery, and flexible electronic equipment to be driven by electric power supplied from the thin battery, and in which the thin battery and the electronic equipment are integrated together to form a sheet. Even when such a battery-mounted device is significantly bent in an arc shape, breakage of the first electrode located at the outermost side is suppressed. Therefore, the lifetime of the device can be prolonged.

Examples of the electronic equipment to be integrated together with the thin battery to form a sheet include a biological wearable device or a wearable portable terminal, a portable telephone, a recording and playing-back device, a wristwatch, a video and still camera, a liquid crystal display, an electronic calculator, an IC card, a temperature sensor, a hearing aid, a pressure-sensitive buzzer, and the like. In particular, since the biological wearable device is used in such a manner as to be in close contact with a living body, flexibility is required. Examples of the biological wearable device include a biological information measuring device, an iontophoretic dermal administration device, and the like.

The thickness of the thin battery is not particularly limited, and is preferably 3 mm or less, and further preferably 2 mm or less, in view of the flexibility. The thickness of the sheet-like battery-mounted device may be larger than the thickness of the thin battery. However, from the same viewpoint as mentioned above, the thickness is preferably 3 mm or less. However, when the thin battery and the battery-mounted device have a thickness of about 5 mm or less, relatively excellent flexibility can be obtained. It is technically difficult to extremely reduce the thickness, the lower limit of the thickness is, for example, 50 μm.

Hereinafter, exemplary embodiments of the present invention are described in more detail. However, the following exemplary embodiments are not constructed to limit the scope of the present invention.

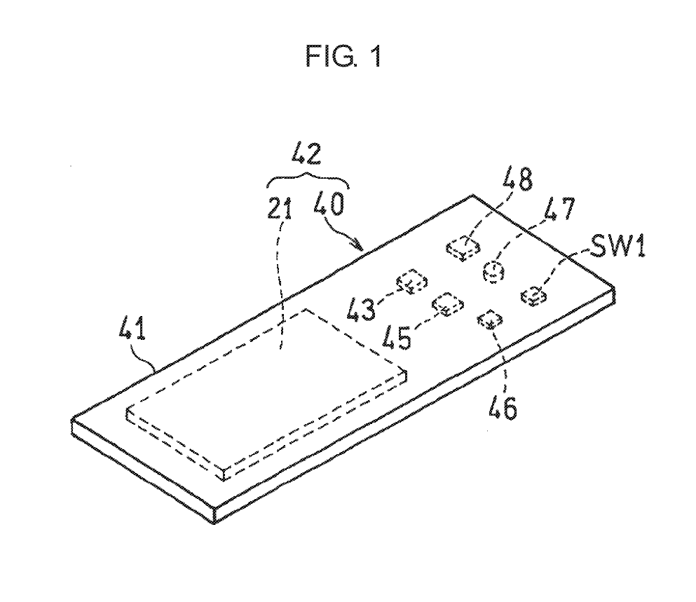

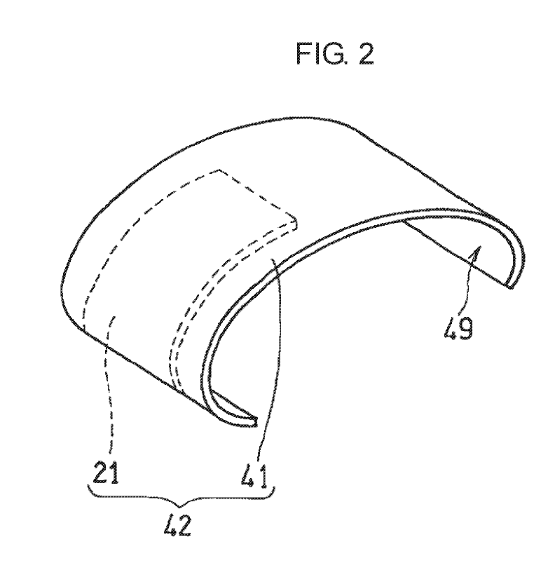

FIG. 1 is a perspective view showing an example of battery-mounted device 42 provided with a biological information measuring device as electronic equipment. FIG. 2 shows an example of an appearance of the device when the device is deformed.

Biological information measuring device 40 includes sheet-like holding member 41 for holding component elements thereof and a thin battery. Holding member 41 is made of a flexible material. Elements such as temperature sensor 43, pressure-sensitive element 45, memory 46, information transmitter 47, button switch SW1, and controller 48 are embedded in holding member 41. Thin battery 21 occupies a flat space provided inside holding member 41. That is to say, thin battery 21 and biological information measuring device 40 are integrated together to form a sheet so as to produce battery-mounted device 42. For holding member 41, for example, an electrically insulated resin material can be used. Applying, for example, adhesive 49 having adhesive strength to one main surface of battery-electronic device assembly 42 enables battery-mounted device 42 to be placed around the wrist, ankle, neck, and other parts of the user.

Temperature sensor 43 includes, for example, a heat-sensitive element such as a thermistor or a thermocouple; and outputs signals indicating a body temperature of a user, to controller 48. Pressure-sensitive element 45 outputs signals indicating blood pressure and pulse of a user, to controller 48. For memory 46 which stores information corresponding to the signals that have been output, for example, a nonvolatile memory can be used. Information transmitter 47 converts necessary information into radio waves in response to the signals from controller 48, and then radiates the radio waves. Switch SW1 is used for turning on or off biological information measuring device 40. Temperature sensor 43, pressure-sensitive element 45, memory 46, information transmitter 47, switch SW1, and controller 48 are placed to, for example, a flexible substrate, and electrically connected to each other by a wiring pattern formed on the surface of the substrate.

Controller 48 includes a CPU (Central Processing Unit) for executing a predetermined operation processing, ROM (Read Only Memory) storing a control program of the device, RAM (Random Access Memory) for temporarily storing data, and peripheral circuits thereof. The control program stored in the ROM is executed so as to control an operation of each part of biological information measuring device 40.

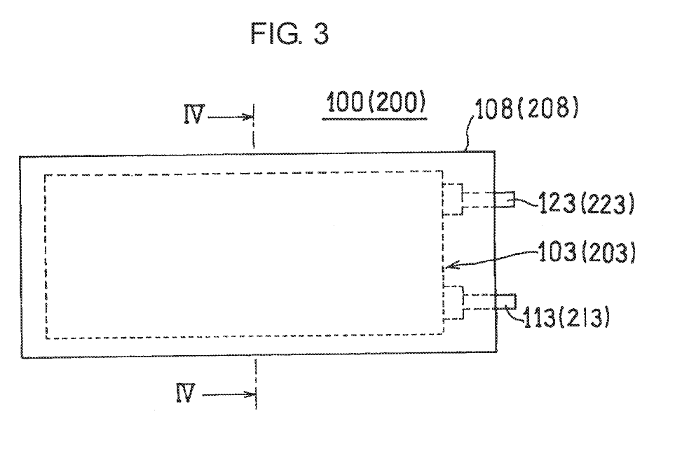

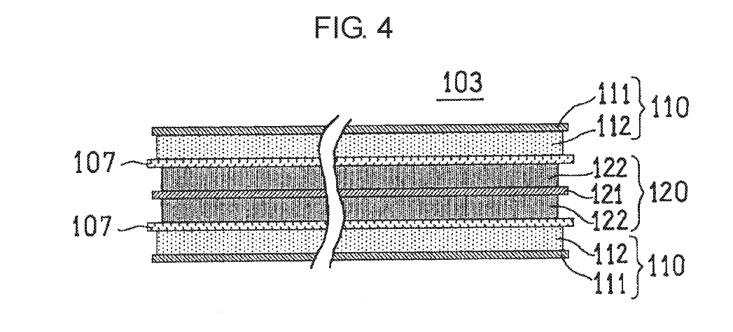

Next, a thin battery in accordance with the first exemplary embodiment of the present invention is described with reference to FIGS. 3 and 4.

FIG. 3 is a plan view of an example of the thin battery. FIG. 4 is a longitudinal sectional view conceptually showing an example of an electrode assembly having the simplest structure. Note here that FIG. 4 is a sectional view taken on line IV-IV of the thin battery shown in FIG. 3.

Thin battery 100 includes electrode assembly 103, non-aqueous electrolyte (not shown), and housing 108 for housing or accommodating electrode assembly 103 and the non-aqueous electrolyte. Electrode assembly 103 includes a pair of first electrodes 110 located at the outer sides, second electrode 120 disposed between the pair of first electrodes 110, and separator 107 interposed between each of first electrodes 110 and second electrode 120. First electrode 110 includes first current collector sheet 111 and first active material layer 112 attached to one surface of first current collector sheet 111. Second electrode 120 includes second current collector sheet 121 and second active material layers 122 attached to both surfaces of second current collector sheet 121. The pair of first electrodes 110 are disposed with second electrode 120 sandwiched therebetween such that first active material layer 112 and second active material layer 122 face each other with separator 107 interposed therebetween. First lead 113 is connected to first current collector sheet 111, and second lead 123 is connected to second current collector sheet 121. One end portion of first lead 113 and one end portion of second lead 123 are extended from housing 108 to the outside, respectively. The extended end portions serve as a positive electrode external terminal or a negative electrode external terminal. Note here that, a sealing material may be interposed between housing 108 and each lead in order to enhance sealing property. For the sealing material, thermoplastic resin can be used.

First separator 107 is bonded to first active material layer 112 and second active material layer 122. A preferable method for bonding the first separator to each active material layer includes a method for applying a resin swollen with a non-aqueous electrolyte onto the surface of the first separator and/or the surface of each active material layer. When the resin is swollen with a non-aqueous electrolyte, a gel electrolyte is formed. The gel electrolyte functions as an adhesive agent.

In electrode assembly 103, sliding resistance R11 between first separator 107 and each of first active material layers 112 and sliding resistance R12 between first separator 107 and each of second active material layers 122 need to satisfy mathematical expression

0.5 N/cm²≦R11<R12≦2.3 N/cm². (1)

Thus, even when thin battery 100 is significantly bent in an arc shape, before first electrode 110 to which the largest a tensile load is applied breaks, sliding occurs between first active material layer 112 and first separator 107. Thus, a tensile stress is relieved.

A ratio of R11 to R12, R11/R12, preferably satisfies 0.22≦R11<R12≦0.95, and more preferably satisfies 0.22≦R11<R12≦0.90. This enables sliding to occur more smoothly between first active material layer 112 and first separator 107 when thin battery 100 is bent. Furthermore, R11 may be 0.5 N/cm² or more. In view of enhancing an effect of suppressing separation in the electrode assembly, R11 is preferably 0.7 N/cm² or more. Furthermore, R12 may be 2.3 N/cm² or less. In view of sufficiently providing the electrode assembly with flexibility necessary to a wearable portable terminal, R12 is preferably 2.0 N/cm² or less.

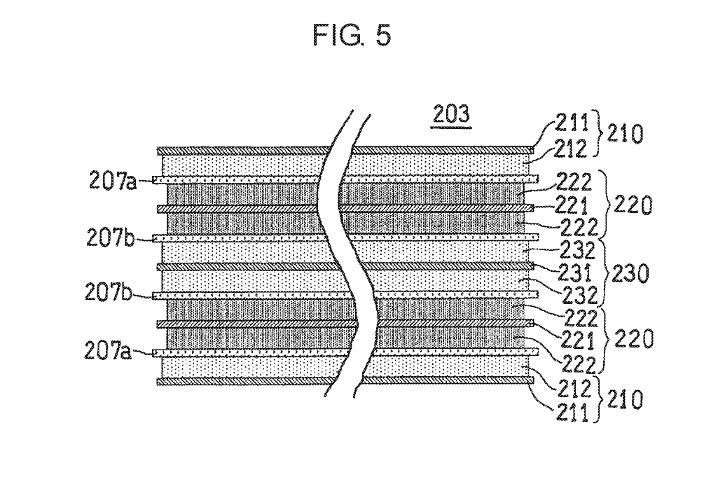

Next, thin battery 200 in accordance with a second exemplary embodiment of the present invention is described with reference to FIG. 5.

FIG. 5 is a longitudinal sectional view conceptually showing an example of an electrode assembly having the second simplest structure provided in a thin battery.

Electrode assembly 203 includes a pair of first electrodes 210 disposed at the outermost sides, a pair of second electrodes 220 disposed therebetween, third electrode 230 disposed between the pair of second electrode 220 (that is, in the center), first separator 207a interposed between each of first electrodes 210 and each of second electrodes 220, and second separator 207b interposed between each of second electrodes 220 and third electrode 230. First electrodes 210 and third electrode 230 have the same polarity.

Configurations of first electrodes 210 and second electrodes 220 are the same as those in the first exemplary embodiment. That is to say, each first electrode 210 includes first current collector sheet 211 and first active material layer 212 attached to one surface of first current collector sheet 211. Each second electrode 220 includes second current collector sheet 221 and second active material layers 222 attached to both surfaces of second current collector sheet 221. Third electrode 230 has the same configuration as that of each first electrode 210 except that it has active material layers on both surfaces thereof. Third electrode 230 includes third current collector sheet 231 and third active material layers 232 attached to both surfaces of third current collector sheet 231.

First lead 213 is connected to first current collector sheet 211; second lead 223 is connected to second current collector sheet 221, and third lead (not shown) is connected to third current collector sheet 231. Since the third lead has the same polarity as that of first lead 213, it is connected to first lead 213 inside housing 208. One end portion of first lead 213 and one end portion of second lead 223 extended from housing 208 to the outside, respectively. The extended end portions serve as a positive electrode external terminal or a negative electrode external terminal.

Also in electrode assembly 203, sliding resistance R11 between first separator 207a and first active material layer 212 and sliding resistance R12 between first separator 207a and each second active material layer 222 have the same relation as that in the first exemplary embodiment, and needs to satisfy mathematical expression

0.5 N/cm²≦R11<R12≦2.3 N/cm². (1)

As long as the relation of the above-mentioned mathematical expression (1) is satisfied, an effect of suppressing breakage of first electrode 210 is obtained. Furthermore, when the following mathematical expressions (2) and (3) are satisfied, the effect of suppressing breakage of first electrodes 210 is improved. That is to say, sliding resistance R22 between second separator 207b and second active material layer 222 preferably satisfies mathematical expression

R11<R22≦2.3 N/cm², (2)

and sliding resistance R23 between second separator 207b and third active material layer 232 preferably satisfies mathematical expression

R11<R23≦2.3 N/cm². (3)

When the above-mentioned mathematical expressions (2) and (3) are satisfied, sliding resistance R11 between first active material layer 212 of first electrodes 210 at the outermost sides and first separator 207a becomes always minimum. Therefore, when thin battery 203 is significantly bent in an arc shape, at the interface between first active material layer 212 and first separator 207a, sliding occurs always preferentially and a tensile load is relieved. Furthermore, since R22≦2.3 N/cm² and R23≦2.3 N/cm² are satisfied, also at the interface between the second electrode or the third electrode and the second separator, sliding occurs before excessive stresses accumulate.

On the other hand, if the relation R22<R11 or R23<R11 is satisfied, before sliding occurs between first separator 207a and first active material layer 212, sliding may occur preferentially at a more inner interface. Thus, the distortion in the entire electrode assembly is relieved, so that the sliding does not easily occur between first separator 207a and each first active material layer 212. However, even after the distortion in the entire electrode assembly is relieved, the largest tensile load is still applied to first electrode 210. Consequently, there is a possibility that the strength of first electrode 210 is gradually reduced, and first electrode 210 finally breaks.

It is preferable that the ratio of R11 to R22, R11/R22, satisfies 0.22≦R11<R12≦0.95. This enables sliding between first active material layer 212 and first separator 107 to occur more smoothly. Furthermore, R22 may be 0.5 N/cm² or more. In view of enhancing an effect of suppressing separation in the electrode assembly, R22 is preferably 0.7 N/cm² or more. Furthermore, R22 may be 2.3 N/cm² or less. In view of sufficiently providing the electrode assembly with flexibility necessary to a wearable portable terminal, R22 is preferably 2.0 N/cm² or less.

Similarly, it is preferable that the ratio of R11 to R23, R11/R23, satisfies 0.22≦R11<R23≦0.95. Furthermore, R23 is preferably 0.7 N/cm² or more, and 2.0 N/cm² or more or less.

Note here that when the number n of the second electrodes becomes too large, the thickness of the thin battery becomes large, thus reducing the merit of the thin battery. Therefore, preferably n≦15 is satisfied, and more preferably n≦10 is satisfied. When the thickness of the thin battery is, for example, 3 mm or less, regardless of the number n of the second electrodes, an effect of suppressing breakage of the first electrode can be obtained. However, when n≦10 is satisfied, the effect by which the mathematical expression (1) is satisfied and the effect by which the mathematical expressions (2) to (3) are satisfied are increased.

It is preferable that porosity A of the first active material layer is larger than porosity B of the second active material layer. For example, the porosity A is preferably 20 to 80%, and the porosity B is smaller than this range. Thus, a contact area between the first active material layer and the first separator is smaller than a contact area between the second active material layer and the first separator. Thus, sliding resistance R11 can be made smaller than R12 easily. Furthermore, since the first electrode has the first active material layer only on one surface of the first current collector sheet, warping is likely to occur. Even when the degree of warping of the first electrode is small, the warping becomes apparent in a thin battery having a small thickness. This may make it difficult to install the thin battery on electronic equipment, or may give uncomfortable feeling to a user. On the other hand, when the porosity A of the first active material layer is controlled to fall within the above-mentioned range, it is possible to obtain an accompanying effect that warping of the first electrode can be reduced.

It is preferable that at least a part of the non-aqueous electrolyte with which the electrode assembly is impregnated forms a gel electrolyte. It is preferable that the gel electrolyte is located at least in the interface region between each active material layer and each separator. When the gel electrolyte is located in the interface region between each active material layer and each separator, the adhesiveness between the electrode and the separator is improved and separation is further suppressed. It is further preferable that the gel electrolyte is also located inside air gaps of the active material layer and/or in pores of each separator.

The gel electrolyte includes, for example, a non-aqueous electrolyte and a resin swollen with the non-aqueous electrolyte. As the resin swollen with the non-aqueous electrolyte, a fluorocarbon resin including a polyvinylidene fluoride unit is preferred. The fluorocarbon resin including a polyvinylidene fluoride unit easily retains a non-aqueous electrolyte and is easily gelled.

When a gel electrolyte is disposed in the interface region between the active material layer and the separator, the resin swollen with a non-aqueous electrolyte is applied, for example, in a film shape and, for example, on the surface of the active material layer and/or the surface of the separator. Thereafter, the active material layer and the separator are laminated via a resin coating film, and the obtained laminated body or electrode assembly is impregnated with a non-aqueous electrolyte. Thus, the resin is swollen with the non-aqueous electrolyte so as to form a gel electrolyte in the interface region. When the gel electrolyte uses a fluorocarbon resin including a polyvinylidene fluoride unit, it is preferable that the amount of resin contained in the coating film is 1 to 30 g/m² per area of the interface region between the active material layer and the separator (that is, per unit area of the active material layer or the separator).

The resin swollen with the non-aqueous electrolyte need not be applied onto the entire surface of the active material layer and/or the entire surface of the separator. For example, the resin may be applied on the surface of the active material layer in a predetermined pattern (for example, in a stripe pattern or a matrix pattern) or in a dotted manner. Similarly, the resin may be applied onto the surface of the separator in a predetermined pattern or in a dotted manner. At this time, by the amount of the resin applied to the surface of the active material layer and/or the separator, the sliding resistance R11, R12, R22 and R23 can be controlled.

The interface region between the active material layer and the separator can be classified into a first region between the first active material layer and the first separator, a second region between each of the second active material layers and the first separator, a third region between each of the second active material layers and the second separator, as well as a fourth region between the third active material layer and the second separator. When the gel electrolyte is disposed in the first region and the second region, it is preferable that the gel electrolyte is distributed more in the second region than in the first region. This facilitates controlling the sliding resistance R11 to be smaller than R12. This is because the gel electrolyte functions as an adhesive agent, and therefore the less the distributed amount of the gel electrolyte is, the less the sliding resistance becomes. Note here that the relation between sliding resistance R11 and R12 can be easily controlled when the ratio of W1 to W2, W1/W2, satisfies 0≦W1/W2≦0.95, where W1 is an amount per unit surface area of the resin swollen with a non-aqueous electrolyte contained in the first region and W2 is an amount per unit surface area of the resin swollen with a non-aqueous electrolyte contained in the second region.

When the gel electrolyte is disposed also in the third region and the fourth region, for the same reason, it is preferable that the gel electrolyte is distributed less in the first region than in the second to fourth regions. Thus, the relations: R11<R12, R11<R22 and R11<R23 are easily established.

A method for allowing the gel electrolyte to be contained in the inside of air gaps of the active material layer is desirably a method for allowing the resin swollen with a non-aqueous electrolyte to be contained in raw material of the active material layer. This method is desirable because it is simple. For example, when the first active material layer is a mixture layer including a first active material and a first binder, the resin swollen with a non-aqueous electrolyte may be contained in the first binder. Similarly, when the second active material layer is a mixture layer including a second active material and a second binder, the resin swollen with a non-aqueous electrolyte may be contained in the second binder. Such a mixture layer can be formed by applying mixture slurry including the first or second active material, the first or second binder, and a liquid dispersion medium for dispersing thereof onto the first or the second current collector sheet, followed by drying, and then pressing the coating film.

When the first active material layer includes the first active material and the first binder, the second active material layer includes the second active material and the second binder, and the gel electrolyte is disposed to the first region and second region, both the first binder and the second binder preferably include the resin swollen with a non-aqueous electrolyte. This enhances the integrating property of each active material layer and the separator and further suppresses separation between each electrode and the separator. At this time, it is further preferable that the first binder, the second binder, and the gel electrolyte include the resin swollen with a non-aqueous electrolyte in the same type. For example, when the gel electrolyte includes polyvinylidene fluoride, it is preferable that the first active material layer, the second active material layer and further the third active material layer also include polyvinylidene fluoride.

Similarly, when the first active material layer includes the first active material and the first binder, the second active material layer includes the second active material and the second binder, the third active material layer includes the third active material and a third binder, and a gel electrolyte is disposed in the above-mentioned first to fourth regions, it is preferable that all of the first binder, the second binder, and the third binder include the resin swollen with the non-aqueous electrolyte. It is further preferable that the first binder, the second binder, the third binder, and the gel electrolyte include the resin swollen with the non-aqueous electrolyte in the same type. Note here that in general, the first and third active materials having the same polarity are in the same type, and the first binder and the third binder are also in the same type.

In any of the exemplary embodiments, the porosity A of the first active material layer is preferably 20 to 80% inclusive, and further preferably 25 to 60% inclusive. However, when the first active material layer is a positive electrode, the porosity A is preferably 20 to 30% inclusive, and more preferably 20 to 27% inclusive. Furthermore, when the first active material layer is a negative electrode, the porosity A is preferably 25 to 80% inclusive, and more preferably 40 to 60% inclusive. At this time, the porosity B of the second active material layer is smaller than the porosity A. It is preferable that the ratio A/B of the porosity A to the porosity B is, for example, 1.03 to 4.5 inclusive. Furthermore, the porosity C of the third active material layer is not more than the porosity A, and the ratio A/C of the porosity A to the porosity C may be, for example, 1 to 4 inclusive.

Examples of the resin (matrix polymer) retaining and swollen with a non-aqueous electrolyte include a fluorocarbon resin including a polyvinylidene fluoride unit, acrylic resin including (meth)acrylic acid and/or (meth)acrylic ester unit, and polyether resin including a polyalkylene oxide unit, and the like.

Examples of the fluorocarbon resin including a polyvinylidene fluoride unit include polyvinylidene fluoride (PVdF), a copolymer containing a polyvinylidene fluoride (VdF) unit and a hexafluoropropylene (HFP) unit (PVdF-HFP), and a copolymer containing a polyvinylidene fluoride (VdF) unit and a trifluoroethylene (TFE) unit, and the like. It is preferable that the amount of polyvinylidene fluoride unit contained in the fluorocarbon resin including a polyvinylidene fluoride unit is 1 mol % or more such that the fluorocarbon resin is easily swollen with the non-aqueous electrolyte.

It is preferable that the ratio S1/S2 of the area S1 of the first active material layer to the area S2 of the second active material layer is 0.7 to 1.3 in view of capacity balance. Furthermore, when the first electrode is a negative electrode, and the second electrode is a positive electrode, the ratio S1/S2 is preferably more than 1, and further preferably 1.01 to 1.3 in view of preventing the precipitation of metallic lithium.

On the other hand, it is preferable that the area S3 of the third active material layer having the same polarity as that of the first active material layer is about the same level as the area S1 of the first active material layer in view of securing the capacity balance. For example, it is preferable that the ratio S1/S3 of the area S1 to the area S3 satisfies 0.95≦S1/S3≦1.05.

Note here that the areas S1, S2, and S3 of the active material layers have the same meaning as the projected areas (S) of each active material layer seen from the normal direction (the direction perpendicular to the planer direction of the current collector sheet).

The housing is formed of, for example, a laminate film including a barrier layer, and resin layers respectively formed on both surfaces of the barrier layer. Inorganic materials to be used for the barrier layer are not particularly limited. For the inorganic materials, a metal layer, a ceramics layer, or the like, is suitably used in view of the barrier performance, strength, bending resistance, or the like. Preferable examples of the inorganic material include: metal materials such as aluminum, titanium, nickel, iron, platinum, gold, and silver; and ceramics materials such as silicon oxide, magnesium oxide, and aluminum oxide. It is preferable that the thickness of the barrier layer is, for example, 0.01 to 50 μm. In view of easiness of thermal welding, electrolyte resistance, and chemical resistance, material for the resin layer disposed at the inner side of the housing is preferably a polyolefin such as polyethylene (PE) or polypropylene (PP); polyethylene terephthalate, polyamide, polyurethane, polyethylene-vinyl acetate (EVA) copolymer, or the like. It is preferable that the thickness of the resin layer at the inner surface side is 10 to 100 μm. In view of strength, shock resistance, and chemical resistance, the resin layer disposed at the outer surface side of the housing is preferably a polyamide (PA) such as 6,6-nylon; a polyolefin; and a polyester such as polyethylene terephthalate (PET), polybutylene terephthalate, or the like. It is preferable that the thickness of the resin layer at the outer surface side is 5 to 100 μm.

When the first electrode is a positive electrode, the second electrode is a negative electrode. At this time, the third electrode is a positive electrode. When the first electrode is a negative electrode, the second electrode is a positive electrode. At this time, the third electrode is a negative electrode. Hereinafter, the configurations of the positive electrode and the negative electrode are described in more detail.

### Negative Electrode

A negative electrode includes a negative electrode current collector sheet as a first or second current collector sheet, and a negative electrode active material layer as a first or second active material layer. When the first electrode is a negative electrode, the negative electrode active material layer is provided on one surface of the negative electrode current collector sheet. When the second electrode or the third electrode is a negative electrode, the negative electrode active material layers are provided on both surfaces of the negative electrode current collector sheet.

For the negative electrode current collector sheet, a metal film, a metal foil, or the like, is used. It is preferable that the negative electrode current collector sheet does not form an alloy with the negative electrode active material and has excellent electron conductivity. Thus, a material of the negative electrode current collector is preferably at least one selected from the group consisting of; copper, nickel, titanium, and an alloy thereof; and stainless steel. It is preferable that the thickness of the negative electrode current collector sheet is, for example, 5 to 30 μm.

The negative electrode active material layer includes a negative electrode active material, and includes a binder and a conductive agent, if necessary. The negative electrode active material layer may be a porous deposited film formed by a gas phase method (for example, vapor deposition). Examples of the negative electrode active material includes Li metal, metal or an alloy electrochemically reacting with Li, or a carbon material (for example, graphite), a silicon alloy, silicon oxide, or the like. The thickness of the negative electrode active material layer is preferably 1 to 300 μm. When the thickness of the negative electrode active material layer is 1 μm or more, sufficient capacity can be kept. On the other hand, when the thickness of the negative electrode active material layer is 300 μm or less, the negative electrode can keep high flexibility, and a stress to the thin battery is less likely to occur when the thin battery is bent.

When the first electrodes disposed at the outermost sides of the electrode assembly are a negative electrode, a binder of each of the negative electrode active material layers preferably includes a fluorocarbon resin including a polyvinylidene fluoride unit. Among thin batteries using a non-aqueous electrolyte, a negative electrode of a lithium ion secondary battery mainly includes a carbon material as the active material. When the carbon material is used as the active material, in view of capable of achieving bind strength with a small amount, rubber particles (for example, styrene-butadiene rubber) is used as a binder. On the other hand, when rubber particle is used, when the electrode assembly is significantly bent, separation may occur at the interface between the negative electrode and the separator. On the other hand, when a fluorocarbon resin including a polyvinylidene fluoride unit is used as a binder, a non-aqueous electrolyte included in the first active material layer (negative electrode active material layer) is gelled, and therefore, a bonding force between the first active material layer and the separator is increased, and the separation is suppressed.

### Positive Electrode

A positive electrode includes a positive electrode current collector sheet as a first or second current collector sheet, and a positive electrode active material layer as first or second active material layer. When the first electrode is a positive electrode, the positive electrode active material layer is provided on one surface of the positive electrode current collector sheet. When the second electrode or the third electrode is a positive electrode, the positive electrode active material layers are provided on both surfaces of the positive electrode current collector sheet.

For the positive electrode current collector sheet, a metal film, a metal foil, or the like, is used. Thus, a material of the positive electrode current collector sheet is preferably, for example, at least one selected from the group consisting of silver, nickel, palladium, gold, platinum, aluminum, and an alloy thereof; and stainless steel. The thickness of the positive electrode current collector sheet is preferably, for example, 1 to 30 μm.

The positive electrode active material layer includes a positive electrode active material and a binder, and, if necessary, a conductive agent. The positive electrode active material is not particularly limited. When the thin battery is a secondary battery, suitable materials include a lithium-containing composite oxide such as LixₐCoO₂, LiₓₐNiO₂, LiₓₐMnO₂, LiₓₐCo_{y}Ni_{1-y}O₂, LiₓₐCO_{y}M_{1-y}O_{z}, LiₓₐNi_{1-y}M_{y}O_{z}, Li_{xb}Mn₂O₄, Li_{xb}Mn_{2-y}M_{y}O₄, or the like. Herein, M is at least one element selected from the group consisting of Na, Mg, Sc, Y, Mn, Fe, Co, Ni, Cu, Zn, Al, Cr, Pb, Sb, and B; xa=0 to 1.2; xb=0 to 2; y=0 to 0.9; and z=2 to 2.3, are satisfied. The values xa and xb increase and decrease by charge and discharge. When the thin battery is a primary battery, at least one selected from the group consisting of manganese dioxide, fluorinated carbon (fluorinated graphite), a lithium-containing composite oxide, a metal sulfide, and an organic sulfur compound. The thickness of the positive electrode active material layer is preferably, for example, 1 to 300 μm. When the thickness of the positive electrode active material layer is 1 μm or more, sufficient capacity can be kept. On the other hand, when the thickness of the positive electrode active material layer is 300 μm or less, the positive electrode can keep high flexibility, and a stress to the thin battery is less likely to occur when the thin battery is bent.

When the first electrodes disposed at the outermost sides of the electrode assembly are a positive electrode, the binder of the first active material layer preferably includes a fluorocarbon resin including a polyvinylidene fluoride unit. Thus, the non-aqueous electrolyte contained in the first active material layer (positive electrode active material layer) is gelled, and therefore, bonding force between the first active material layer and the separator is increased, and the separation is suppressed.

Examples of the conductive agent to be contained in the active material layer of the positive electrode or the negative electrode include graphites such as natural graphite and artificial graphite; and carbon blacks such as acetylene black, Ketjen black, channel black, furnace black, lamp black, and thermal black. An amount of the conductive agent is, for example, 0 to 20 parts by mass with respect to 100 parts by mass of the active material.

Examples of the binder to be contained in the active material layer of the positive electrode or the negative electrode include fluorocarbon resins including a polyvinylidene fluoride unit, for example, polyvinylidene fluoride (PVDF); fluorocarbon resins without including a polyvinylidene fluoride unit, for example, polytetrafluoroethylene; acrylic resins such as polyacrylonitrile and polyacrylic acid; and rubbers such as styrene-butadiene rubber. An amount of the binder is, for example, 0.5 to 15 parts by mass with respect to 100 parts by mass of the active material.

In each active material layer, the fluorocarbon resin including a polyvinylidene fluoride unit may be used together with the other binders. In this case, it is preferable to include 10 mass % or more of the fluorocarbon resin including a polyvinylidene fluoride unit with respect to the whole amount of the binder.

It is preferable that the non-aqueous electrolyte is a mixture of a lithium salt and a non-aqueous solvent for dissolving lithium salt. Examples of the lithium salt include LiClO₄, LiBF₄, LiPF₆, LiCF₃SO₃, LiCF₃CO₂, and imide salts. Examples of the non-aqueous solvent include: cyclic carbonic acid esters such as propylene carbonate, ethylene carbonate, and butylene carbonate; chain carbonic acid esters such as diethyl carbonate, ethyl methyl carbonate, and dimethyl carbonate; and cyclic carboxylic acid esters such as γ-butyrolactone and γ-valerolactone.

For the separator, resin microporous membrane or non-woven fabric is preferably used. Preferable examples of the material (resin) for the separator include a polyolefin such as polyethylene and polypropylene; polyamides such as polyamide and polyamide-imide, or the like. The thickness of the separator is, for example, 8 to 30 μm.

The negative electrode lead and the positive electrode lead are connected by welding to, for example, a negative electrode current collector sheet or a positive electrode current collector sheet, respectively. Preferred examples of the negative electrode lead include a copper lead, a copper alloy lead, and a nickel lead. Preferred examples of the positive electrode lead include a nickel lead and an aluminum lead.

Hereinafter, the present invention is described in more detail with reference to Examples. However, the present invention is not construed to be limited to Examples.

### Example 1

A thin battery having a structure of “negative electrode-positive electrode-negative electrode” was produced by the following procedures.

### (1) Production of Negative Electrode (First Electrode)

For a negative electrode current collector sheet, 8 μm-thick electrolytic copper foil was prepared. Negative electrode mixture slurry was applied to one surface of the electrolytic copper foil, followed by drying, and then pressing the resultant product so as to form a negative electrode active material layer (first active material layer), and to obtain a negative electrode sheet. In pressing, a linear pressure was controlled so that porosity of the negative electrode active material layer became 47%. A negative electrode was cut out from the resultant negative electrode sheet such that the negative electrode was 23 mm×55 mm in size and had a 5 mm×5 mm tab. Then, a negative electrode lead made of copper was ultrasonically welded to the tab. The negative electrode mixture slurry was prepared by mixing 100 parts by mass of graphite (average particle diameter: 22 μm) as the negative electrode active material, 8 parts by mass of polyvinylidene fluoride (PVdF) as the binder, and an appropriate amount of N-methyl-2-pyrrolidone (NMP) with each other. A thickness of the negative electrode active material layer was 145 μm.

### (2) Production of Positive Electrode (Second Electrode)

For a positive electrode current collector sheet, 15 μm-thick aluminum foil was prepared. Positive electrode mixture slurry was applied to both surfaces of the aluminum foil, followed by drying, and then pressing the resultant product so as to form a positive electrode active material layer (second active material layer), and to obtain a positive electrode sheet. In pressing, a linear pressure was controlled so that porosity of the positive electrode active material layer was 22%. A positive electrode was cut out from the resultant positive electrode sheet such that the positive electrode was 21 mm×53 mm in size and had a 5 mm×5 mm tab. Then, a positive electrode lead made of aluminum was ultrasonically welded to the tab. The positive electrode mixture slurry was prepared by mixing 100 parts by mass of LiNi_{0.8}Co_{0.16}Al_{0.4}O₂ (average particle diameter: 20 μm) as the positive electrode active material, 0.75 parts by mass of acetylene black as the conductive agent, 0.75 parts by mass of PVdF as a binder, and an appropriate amount of NMP with each other. A thickness (per one side surface) of the positive electrode active material layer was 80 μm.

The thickness of each active material layer was controlled such that the capacity ratio Cn/Cp of the negative electrode capacity Cn to the positive electrode capacity Cp became 1.05. The ratio Sn/Sp of the area Sn of the negative electrode active material layer to the area Sp of the positive electrode active material layer was 1.1. The same is true to the Cn/Cp ratio and the Sn/Sp ratio in the following Examples and Comparative Examples.

### (3) Non-Aqueous Electrolyte

A non-aqueous electrolyte was prepared by dissolving LiPF₆ in a mixed solvent of ethylene carbonate (EC), ethyl methyl carbonate (EMC), and diethyl carbonate (DEC) (volume ratio: 20:30:50) at a concentration of 1 mol/L.

### (4) Assembling of Thin Battery

A polymer solution was prepared by dissolving 5 parts by mass of PVdF in 100 parts by mass of the above-mentioned mixture solvent. The resultant polymer solution was applied to both surfaces of a separator (first separator) made of a microporous polyethylene film (thickness: 9 μm) having a size of 23 mm×59 mm, vaporizing the solvent in a drying furnace to form a PVdF film. The amount of PVdF applied was 15 g/m².

At this time, a PVdF film was formed in a region corresponding to 90% of a portion of the separator to face the negative electrode active material layer. On the other hand, to a portion of the separator to face the positive electrode active material layer, the PVdF film was formed so as to cover 100% of the portion to face the positive electrode active material layer. Thereafter, the positive electrode was disposed between a pair of negative electrodes such that the negative electrode active material layer and the positive electrode active material layer face each other and the separator was interposed between the negative electrode and the positive electrode, to obtain an electrode assembly.

Next, the electrode assembly was housed in a housing formed of a tubular laminated film having a barrier layer of aluminum. Herein, a laminate film having a total thickness of about 85 μm and having a three-layered structure of a polypropylene (PP) layer, an aluminum foil, and a nylon (Ny) layer was used. The PP layer was disposed at the inner side and the Ny layer was disposed at the outer side.

The positive electrode lead and the negative electrode lead were extended from a first opening of the housing. The first opening was sealed by thermal welding with the positive and negative electrode leads sandwiched therebetween. Next, a non-aqueous electrolyte was injected from a second opening thereof, and the second opening was sealed by thermal welding under a reduced pressure of −650 mmHg. Furthermore, the battery after injection was subjected to aging at 45° C. At this time, the PVdF film between the separator and the electrode is impregnated with the non-aqueous electrolyte, so that a gel electrolyte layer is formed. Finally, the resultant was pressed at a pressure of 0.25 MPa for 30 seconds at 25° C. to produce a 0.7 mm-thick battery A1 of Example 1.

The configuration of the battery A1 is shown in Table 1 together with configurations of batteries of the following Examples and Comparative Examples.

TABLE 1

| | | | Thermal | PVDF-coated | | | |
|---|---|---|---|---|---|---|---|
| | | | press | region (%) | | | |
| Bat- | Type of electrode | | Temperature | First | Second | Binder | |
| tery | First | Second | (° C.) | side | side | First | Second |
| A1 | negative | positive | 25 | 90 | 100 | PVdF | PVdF |
| A2 | positive | negative | 25 | 90 | 100 | PVdF | PVdF |
| A3 | negative | positive | 25 | 90 | 100 | PVdF | PVdF |
| A4 | negative | positive | 25 | 100 | 100 | PVdF | PVdF |
| A5 | negative | positive | 25 | 90 | 100 | SBR | PVdF |
| A6 | negative | positive | 60 | 90 | 100 | PVdF | PVdF |
| A7 | negative | positive | 60 | 90 | 100 | PVdF | PVdF |
| A8 | negative | positive | 60 | 100 | 100 | PVdF | PVdF |
| A9 | negative | positive | 60 | 90 | 100 | SBR | PVdF |
| A10 | negative | positive | 80 | 100 | 100 | PVdF | PVdF |
| B1 | negative | positive | 90 | 90 | 100 | PVdF | PVdF |
| B2 | negative | positive | 90 | 100 | 100 | PVdF | PVdF |
| B3 | positive | negative | 60 | 100 | 90 | PVdF | PVdF |
| B4 | negative | positive | 90 | 0 | 0 | PVdF | PVdF |

### [Evaluation]

### Initial Battery Capacity

The battery A1 was subjected to the following charge and discharge under an environment at 25° C. to obtain initial capacity (C0). Herein, the design capacity of the battery A1 is 1C (mAh).

(1) Constant current charge: 0.2 CmA (final voltage: 4.2 V)
(2) Constant voltage charge: 4.2 V (final electric current: 0.05 CmA)
(3) Constant current discharge: 0.5 CmA (final voltage: 2.5 V)
Capacity Retention Rate after Bending Test

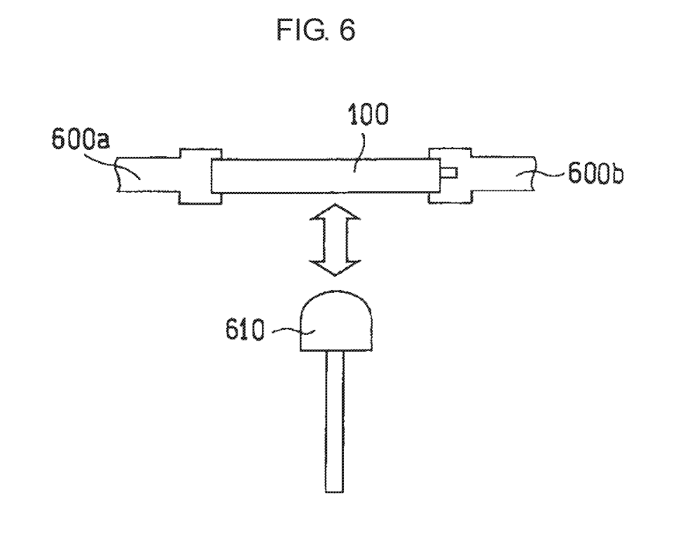

As shown in FIG. 6, a pair of expandable fixing members 600a and 600b were horizontally disposed such that they face each other. The portions closed by thermal welding at both ends of the charged battery A1 were fixed by the fixing members, respectively. Then, in an environment at a temperature of 25° C., jig 610 having a curved surface portion whose radius of curvature R was 20 mm was pressed onto thin battery 100, to bend thin battery along the curved surface portion. Thereafter, jig 610 was separated from thin battery 100, and thin battery 100 was allowed to regain its original shape. This operation was repeated 4000 times. Thereafter, the thin battery was charged and discharged in the same conditions as mentioned above to obtain discharge capacity (Cx) after the bending test. The capacity retention rate was calculated from the obtained discharge capacity Cx and initial capacity C0 based on the following mathematical formula. The results are shown in Table 2.

Capacity retention rate after bending test (%)=(Cx/C0)×100

### Measurement of Sliding Resistance

In the following procedures, sliding resistance R11 between the separator and the negative electrode active material layer (a first active material layer), and sliding resistance R12 between the separator and the positive electrode active material layer (a second active material layer) were measured.

### Resistance R11

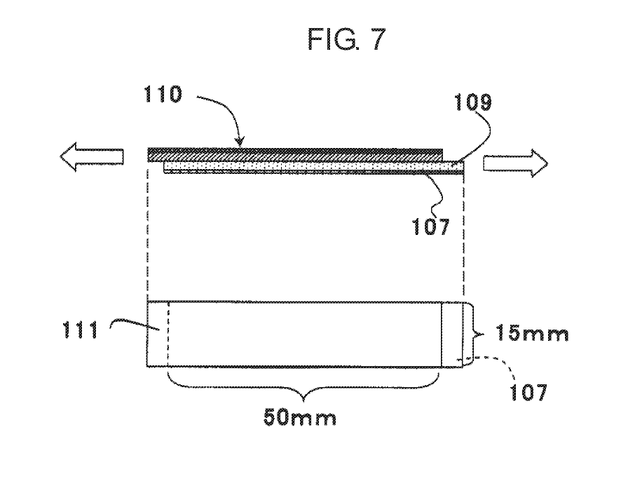

An electrode assembly was taken out from a battery A1 (a battery that is different from the battery subjected to evaluation of the capacity retention rate), the positive electrode active material layer and the separator were separated from each other at the interface therebetween to take off a laminated body of the negative electrode and the separator. Next, the laminated body of negative electrode 110 and separator 107 was processed into a strip-shaped test piece having a joining region having a size of 15 mm×50 mm shown in FIG. 7. In the joining region of the test piece, negative electrode active material layer 112 and separator 107 and bonded to each other with gel electrolyte layer 109.

Next, a tensile load in the longitudinal direction was applied to the test piece under environment at 25° C. at a tensile speed of 20 mm/min by using a tensile tester (TENSILON RTC-1150A manufactured by A&D Company, Limited). The tensile load gradually increases, reaches a peak at a certain time point, and then rapidly decreases. The sliding resistance (N/cm²) was calculated by dividing the load (N) at a peak time by the bonded area (15 mm×50 mm).

### Resistance R12

At one side of the electrode assembly, the negative electrode active material layer and the separator were separated from each other at the interface therebetween, and at the other side of the electrode assembly, the positive electrode active material layer and the separator were separated from each other at the interface therebetween, to take off a laminated body of the positive electrode and the separator. Next, the laminated body of the positive electrode and the separator was processed into a strip-shaped test piece as mentioned above. The test piece was subjected to the tensile test.

Note here that in the portion of the separator to face the negative electrode, PVdF corresponding to 90% of the amount of that in a portion to face the positive electrode. That is to say, the amount of the gel electrolyte disposed in the first region is 90% with respect to the amount of the gel electrolyte disposed in the second region.

### Porosity of Active Material Layer

The pore volume distribution of each active material layer was measured by using a mercury porosimeter. As the porosimeter, Autopore III 9410 manufactured by Shimadzu Corporation was used. From the pore volume distribution, the distribution of pores having a pore diameter of 15 μm or less was extracted (distribution of pores having a pore diameter of more than 15 μm were excluded), and the integrated pore volume (Vp) was obtained. Note here that the pores having a pore diameter of more than 15 μm were not included in the integrated pore volume because the pores are derived from concavity and convexity of the surface of the active material layer. The porosity was obtained from the following mathematical formula by dividing the obtained integrated pore volume Vp by an apparent volume (Va) of the active material layer. The results are shown in Table 1. Va was calculated from a projected area (S) of the active material layer and a thickness (T) of the active material layer (Va=ST). The thickness (T) of the active material layer was measured by using a contact-type thickness measurement device.

Porosity (%)=(Vp/Va)×100

Evaluation results of the battery A1 are shown in Table 2 together with the evaluation results of batteries of the following Examples and Comparative Examples.

TABLE 2

| | Sliding | | | | Capacity retention |
|---|---|---|---|---|---|
| | resistance (N/cm²) | | Porosity (%) | | rate (%) |
| Battery | First side | Second side | First | Second | After 400 bending |
| A1 | 1 | 1.5 | 47 | 22 | 99 |
| A2 | 1 | 1.5 | 47 | 22 | 99 |
| A3 | 1.3 | 1.5 | 22 | 22 | 95 |
| A4 | 1.3 | 1.5 | 47 | 22 | 95 |
| A5 | 0.7 | 1.5 | 47 | 22 | 95 |
| A6 | 1.2 | 1.7 | 47 | 22 | 93 |
| A7 | 1.5 | 1.7 | 22 | 22 | 93 |
| A8 | 1.5 | 1.7 | 47 | 22 | 93 |
| A9 | 1 | 1.7 | 47 | 22 | 96 |
| A10 | 2.1 | 2.3 | 47 | 22 | 91 |
| B1 | 2.4 | 2.9 | 47 | 22 | 64 |
| B2 | 2.7 | 2.9 | 22 | 22 | 51 |
| B3 | 1.7 | 1.2 | 22 | 47 | 70 |
| B4 | 0.4 | 0.4 | 47 | 22 | 75 |

### Example 2

A thin battery having a structure of “positive electrode-negative electrode-positive electrode” was produced by the following procedures.

### (1) Production of Negative Electrode (Second Electrode)

A negative electrode sheet was produced in the same manner as in Example 1 except that negative electrode active material layers were formed on both surfaces of a negative electrode current collector sheet. In pressing, a linear pressure was controlled so that porosity of the negative electrode active material layer was 22%. A negative electrode was cut out from the resultant negative electrode sheet such that the negative electrode was 23 mm×55 mm in size and had a 5 mm×5 mm tab. A negative electrode lead was welded to the tub. Because the porosity was changed from 47% to 22%, the thickness (per one side) of the negative electrode active material layer was 100 μm.

### (2) Production of Positive Electrode (First Electrode)

A positive electrode sheet was produced in the same manner as in Example 1 except that a positive electrode active material layer was formed on one surface of the positive electrode current collector sheet. In pressing, a linear pressure was controlled so that porosity of the positive electrode active material layer was 47%. A positive electrode was cut out from the resultant positive electrode sheet such that the positive electrode was 21 mm×53 mm in size and had a 5 mm×5 mm tab. Then, a positive electrode lead was welded to the tub. Thus, a positive electrode was obtained. Because the porosity was changed from 47% to 22%, the thickness of the positive electrode active material layer was 115 μm.

### (3) Assembling of Thin Battery

An electrode assembly was produced in the same manner as in Example 1 except that the negative electrode was disposed between the pair of positive electrodes such that the negative electrode active material layer and the positive electrode active material layer face each other, thus to complete thin battery (battery A2).

Herein, a PVdF film was formed in a region corresponding to 90% of the portion of the separator to face the positive electrode active material layer (first active material layer). On the other hand, to the portion of the separator to face the negative electrode active material layer (second active material layer), the PVdF film was formed so as to cover 100% of the portion to face the positive electrode active material layer. Thereafter, the electrode assembly was obtained such that the negative electrode active material layer faces the positive electrode active material layer, and such that the positive electrode was disposed between a pair of positive electrodes with the separator interposed between the negative electrode and the positive electrode.

### Example 3

A negative electrode was produced in the same manner as in Example 1 except that a linear pressure was controlled such that the porosity of the negative electrode active material layer became 22%, and a thickness of the negative electrode active material layer was made to be 100 μm. An electrode assembly was produced in the same manner as in Example 1 except that this negative electrode was used, thus to complete a thin battery (battery A3).

### Example 4

An electrode assembly was produced in the same manner as in Example 1 except that a PVdF film was formed in a region corresponding to 100% of the portion of the separator to face the negative electrode active material layer, thus to complete a thin battery (battery A4).

### Example 5

Negative electrode mixture slurry was prepared by mixing 100 parts by mass of graphite (average particle diameter: 20 μm) as a negative electrode active material, 2.5 parts by mass of styrene-butadiene rubber (SBR) as a binder, 1 part by mass of carboxymethylcellulose (CMC), and an appropriate amount of water with each other. A negative electrode was produced in the same manner as in Example 2 except that the prepared negative electrode mixture slurry was used. A thickness of the negative electrode active material layer was 140 μm. An electrode assembly was produced in the same manner as in Example 1 except that this negative electrode was used, thus to complete a thin battery (battery A5).

### Example 6

A thin battery (battery A6) was completed in the same manner as in Example 1 except that a temperature at the time of pressing a thin battery was changed to 60° C.

### Example 7

A thin battery (battery A7) was completed in the same manner as in Example 3 except that a temperature at the time of pressing a thin battery was changed to 60° C.

### Example 8

A thin battery (battery A8) was completed in the same manner as in Example 4 except that a temperature at the time of pressing a thin battery was changed to 60° C.

### Example 9

A thin battery (battery A9) was completed in the same manner as in Example 5 except that a temperature at the time of pressing a thin battery was changed to 60° C.

### Example 10

A thin battery (battery A10) was completed in the same manner as in Example 4 except that a temperature at the time of pressing a thin battery was changed to 80° C.

### Comparative Example 1

A thin battery (battery B1) was completed in the same manner as in Example 1 except that a temperature at the time of pressing a thin battery was changed to 90° C.

### Comparative Example 2

A thin battery (battery B2) was completed in the same manner as in Comparative Example 1 except that the linear pressure was controlled such that the porosity of the negative electrode active material layer became 22%, the thickness of the negative electrode active material layer was made to be 100 μm, and a PVdF layer was applied to a region corresponding to 100% of the portion of the separator to face the negative electrode active material layer.

### Comparative Example 3

A thin battery having a structure of “positive electrode-negative electrode-positive electrode” was produced by the same procedures as in Example 2. However, a PVdF film was formed in a region corresponding to 90% of the portion of the separator to face the negative electrode active material layer, and a PVdF film was formed in a region corresponding to 100% of a portion to face the positive electrode active material layer. Furthermore, in assembling the thin battery, temperatures of the electrode assembly and the non-aqueous electrolyte when the electrode assembly was pressed from the outside of the housing was changed to 60° C. Thus, a thin battery (battery B3), having the same configuration as in Example 6 except that the first electrode was made to be the positive electrode and the second electrode was made to be the negative electrode, was completed.

### Comparative Example 4

A thin battery (battery B4) was completed in the same manner as in Example 1 except that, in assembling a thin battery, a PVdF film was not applied on both surfaces of the separator, an electrode assembly was inserted into the housing, a first opening was sealed by thermal welding, a non-aqueous electrolyte was then injected from a second opening thereof, and the second opening was sealed by thermal welding under a reduced pressure of −650 mmHg, then the battery was subjected to aging at 45° C., and finally, the resultant was pressed at a pressure of 0.25 MPa for 30 seconds at 90° C.

### INDUSTRIAL APPLICABILITY

A thin battery of the present invention is suitable for use in a small-sized electronic equipment such as a biological wearable device or a wearable portable terminal.

### REFERENCE MARKS IN THE DRAWINGS

21, 100, 200: thin battery
40: biological information measuring device
41: holding member
42: battery-mounted device
43: temperature sensor
45: pressure-sensitive element
46: memory
47: information transmitter
SW1: button switch
48: controller
49: adhesive
103, 203: electrode assembly
107: first separator
108, 208: housing
109: gel electrolyte layer
110, 210: first electrode
111, 211: first current collector sheet
112, 212: first active material layer
113, 213: first lead
120, 220: second electrode
121, 221: second current collector sheet
122, 212: second active material layer
123, 223: second lead
207a, 207b: second separator
600a, 600b: fixing member
610: jig

1. A thin battery comprising:
a sheet-like electrode assembly;
a non-aqueous electrolyte with which the electrode assembly is impregnated; and
a housing for accommodating the electrode assembly and the non-aqueous electrolyte in a sealed manner,
wherein the electrode assembly includes a pair of first electrodes disposed at outermost sides of the electrode assembly, at least one second electrode disposed between the pair of first electrodes, and first separators disposed between each of the first electrodes and the second electrode,
each of the first electrodes includes a first current collector sheet and a first active material layer attached to one surface of the first current collector sheet,
the second electrode has a polarity different from a polarity of each of the first electrodes, and includes a second current collector sheet and second active material layers attached to both surfaces of the second current collector sheet,
each of the first separators is bonded to each of the first active material layers and each of the second active material layers, and
sliding resistance R11 between each of the first separators and each of the first active material layers and sliding resistance R12 between each of the first separators and each of the second active material layers satisfy the following mathematical expression 1:
0.5 N/cm²≦R11<R12≦2.3 N/cm².

2. The thin battery of claim 1, wherein the at least one second electrode includes two or more second electrodes,
the battery further comprising one or more third electrodes disposed between a pair of the second electrodes,
wherein the third electrode has the same polarity as a polarity of each of the first electrodes, and includes a third current collector sheet and third active material layers attached to both surfaces of the third current collector sheet,
each of the second electrodes and the third electrode are disposed with second separators interposed therebetween,
sliding resistance R22 between each of the second separators and each of the second active material layers satisfies the following mathematical expression 2:
R11<R22≦2.3 N/cm²; and
sliding resistance R23 between the second separator and each of the third active material layers satisfies the following mathematical expression 3:
R11<R23≦2.3 N/cm².

3. The thin battery of claim 1, wherein
the second electrode comprises n electrodes, and
the third electrode comprises n−1 electrodes,
wherein n is an integer of 3 or more.

4. The thin battery of claim 1, wherein porosity A of the first active material layers is larger than porosity B of the second active material layers.

5. The thin battery of claim 1, wherein at least a part of the non-aqueous electrolyte forms a gel electrolyte,
the gel electrolyte is interposed in a first region between each of the first active material layers and each of the first separators, and in a second region between each of the second active material layers and the first separator, and
the gel electrolyte is distributed more in the second region than in the first region.

6. The thin battery of claim 5, wherein
each of the first active material layers includes a first active material and a first binder;
each of the second active material layers includes a second active material and a second binder; and
the gel electrolyte, the first binder, and the second binder include a resin swollen with the non-aqueous electrolyte.

7. The thin battery of claim 6, wherein the resin is a fluorocarbon resin including a polyvinylidene fluoride unit.

8. A battery-mounted device comprising:
the thin battery as defined in claim 1; and
flexible electronic equipment to be driven by electric power supplied from the thin battery,
wherein the thin battery and the electronic equipment are integrated together to form a sheet.
